(19) United States
(12) Patent Application Publication
(10) Pub. No.: US 2022/0267021 A1
(43) Pub. Date: Aug. 25, 2022

(54) AIRCRAFT HAVING AN ENGINE AND A COOLING SYSTEM BASED ON DIHYDROGEN

(71) Applicant: Airbus Operations SAS, TOULOUSE (FR)

(72) Inventors: Maxime ZEBIAN, TOULOUSE (FR); Davy BOURGALET, TOULOUSE (FR)

(21) Appl. No.: 17/678,176

(22) Filed: Feb. 23, 2022

(30) Foreign Application Priority Data
Feb. 25, 2021 (FR) 2101848

(51) Int. Cl. B64D 37/30; F02C 7/224; F02C 7/16; F02C 7/14

(52) U.S. Cl. CPC B64D 37/30; F02C 7/224; F02C 7/16; F02C 7/14; F05D 2260/213; F05D 2220/323; F05D 2260/205; F05D 2260/98

(57) ABSTRACT

An aircraft having an engine, a dihydrogen tank, devices to be heated, a first air intake for taking in air at a low pressure or at an intermediate pressure, a second air intake for taking in air at a high pressure, a first heat exchanger, a first pipe which passes through the first heat exchanger and feeds the devices to be heated. Upstream of the first heat exchanger, the first pipe is divided into two sub-pipes connected respectively to the first air intake and the second air intake, and a fuel pipe that is connected between the tank and the combustion chamber and passes through the first heat exchanger. The use of heat exchangers on the dihydrogen pipe allows a regulation of the temperature of the devices to be heated and of the engine and to increase the temperature of the dihydrogen before its combustion.

### CROSS-REFERENCES TO RELATED APPLICATIONS

This application claims the benefit of the French patent application No. 2101848 filed on Feb. 25, 2021, the entire disclosures of which are incorporated herein by way of reference.

### FIELD OF THE INVENTION

The present invention relates to an aircraft having an engine and a cooling system based on dihydrogen.

### BACKGROUND OF THE INVENTION

An aircraft conventionally has a fuselage that delimits a cabin for passengers and the flight crew. In the description, the term “cabin” includes not only the cabin in which the passengers are seated, but also the cockpit. The aircraft also has deicing means, for example, for deicing the wings. The cabin and the deicing means constitute devices to be heated.

The aircraft also has at least one turbojet engine which makes it possible to drive the aircraft and which is fed with aviation fuel from a tank.

The aircraft also has an air conditioning system which draws in hot air at the turbojet engine, regulates the temperature of the air thus drawn in, and sends the air thus regulated towards the devices to be heated, including the cabin, in order to regulate the temperature thereof, and the deicing means.

The conditioning system, thus, has heat exchangers, filters, pipes, valves, etc., and it collects the hot air from the turbojet engine in order to treat it and send it towards its destination, in particular, towards the devices to be heated.

FIG. 5 is a schematic depiction of such an aircraft 500 of the prior art. The aircraft 500 has a turbojet engine 501 which incorporates, among other things, a gearbox, and which also has a fan disposed in a fan duct and configured to generate an air flow in the turbojet engine 501 in a direction of movement of the air in the turbojet engine 501, wherein, in a known manner, the air flow then moves downstream of the fan in a primary duct or else in a secondary duct of the turbojet engine 501.

The turbojet engine 501 also has an engine compressor which has a low-pressure compressor downstream of the fan and a high-pressure compressor downstream of the low-pressure compressor, and an engine turbine which has a high-pressure turbine downstream of the high-pressure compressor, and a low-pressure turbine downstream of the high-pressure turbine.

The air which is blown by the fan and passes through the primary duct passes successively through the low-pressure compressor, the high-pressure compressor, the high-pressure turbine and the low-pressure turbine, whereupon the air is ejected towards the outside. Between the high-pressure compressor and the high-pressure turbine, the air passes through a combustion chamber in which the air is mixed with the fuel in order to burn the fuel.

The high-pressure compressor has multiple compression stages in which the pressure increases, from upstream to downstream in the direction of movement, from a low pressure in the first stage to a high pressure in the last stage, passing through intermediate pressures in the intermediate stages.

The aircraft 500 also has devices 504 to be heated (cabin, deicing means) and an air conditioning system 506. The air conditioning system 506 has a first heat exchanger 502, a first air intake 507 configured to draw, from the high-pressure compressor, air at low pressure or at intermediate pressure, and a second air intake 508 configured to draw, from the high-pressure compressor, air at high pressure.

The air conditioning system 506 also has a first pipe 510 which passes through the first heat exchanger 502 and feeds the devices 504 to be heated downstream of the first heat exchanger 502 with respect to the direction of the air flow in the first pipe 510. Upstream of the first heat exchanger 502 with respect to the direction of the air flow in the first pipe 510, the first pipe 510 is divided into two sub-pipes, one of which is fluidically connected to the first air intake 507 and the other of which is fluidically connected to the second air intake 508. Each sub-pipe is, in this instance, equipped with a valve 512, 514 which makes it possible to regulate the passage of the air coming from each air intake 507, 508 depending on the requirements of the aircraft 500, and to this end the aircraft 500 has a control unit configured to command the valves 512 and 514 to open and close.

The air conditioning system 506 also has a first air pipe 516 which feeds the first heat exchanger 502 with air drawn from the fan duct.

Thus, the hot air drawn in at the air intakes 507 and 508 is cooled on passing through the first heat exchanger 502 by the cold air drawn in at the fan duct, which is then heated and released towards the outside or in an engine compartment, while the cooled air is directed towards the devices 504 to be heated through the first pipe 510.

In order for the turbojet engine 501 to be cooled, the aircraft 500 has a second heat exchanger 518 which is configured to effect an exchange of heat between an air flow coming from the fan duct and a flow of oil coming from the turbojet engine 501.

To this end, the aircraft 500 has a second air pipe 520 which draws air from the fan duct in order to feed the second heat exchanger 518, and a first oil circuit 522 that draws oil from the turbojet engine 501 and reinjects this oil after it has passed through the second heat exchanger 518.

Thus, the hot air drawn in at the turbojet engine 501 is cooled on passing through the second heat exchanger 518 by the cold air drawn in at the fan duct, which is then heated and released towards the outside, while the cooled oil is directed towards the turbojet engine 501.

The aircraft 500 has a fuel tank 524 which makes it possible to store aviation fuel and a fuel pipe 526 which feeds the combustion chamber of the turbojet engine 501. A pump 503 is arranged at the outlet of the fuel tank 524 to drive the fuel into the fuel pipe 526.

In order to ensure better cooling of the turbojet engine 501, the aircraft 500 has a third heat exchanger 528 which is configured to effect an exchange of heat between the fuel coming from the fuel tank 524 and a flow of oil coming from the turbojet engine 501.

To this end, the fuel pipe 526 draws fuel from the fuel tank 524 in order to feed the third heat exchanger 528, and a second oil circuit 530 draws oil from the turbojet engine 501 and reinjects this oil after it has passed through the third heat exchanger 528.

Thus, the hot oil drawn in at the turbojet engine 501 is cooled on passing through the third heat exchanger 528 by the fuel drawn from the fuel tank 524, which is then heated and conveyed towards the combustion chamber, while the cooled oil is directed towards the turbojet engine 501.

The aircraft 500 also has an electric generator 532 which generates an electric current for supplying the aircraft 500. In order to ensure the cooling of the electric generator 532, the aircraft 500 has a fourth heat exchanger 534 which is configured to effect an exchange of heat between the fuel coming from the fuel tank 524 and a flow of oil coming from the electric generator 532.

To this end, the fuel pipe 526 draws fuel from the fuel tank 524 in order to feed the fourth heat exchanger 534, and a third oil circuit 536 draws oil from the electric generator 532 and reinjects this oil after it has passed through the fourth heat exchanger 534.

Thus, the hot oil drawn in at the electric generator 532 is cooled on passing through the fourth heat exchanger 534 by the fuel drawn from the fuel tank 524, which is then heated and conveyed towards the combustion chamber, while the cooled oil is directed towards the electric generator 532.

In the embodiment presented here, the fourth heat exchanger 534 is upstream of the third heat exchanger 528 on the fuel pipe 526 with respect to the direction of the flow of fuel in the fuel pipe 526, and the latter therefore passes successively through the fourth heat exchanger 534 and then the third heat exchanger 528 before reaching the combustion chamber.

The aircraft 500 also has a return pipe 538 fluidically connected between the fuel pipe 526 and the fuel tank 524 at a valve 540 which is installed on the fuel pipe 526 between the fourth heat exchanger 534 and the third heat exchanger 528 and is commanded to open and close by the control unit. Thus, the fuel can cool the oil from the electric generator 532 and return into the fuel tank 524 without the fuel being sent towards the combustion chamber.

Although such an installation performs well in the case of a fuel of the aviation fuel type, it is not optimal when the fuel is dihydrogen which is stored in liquid form at a very low temperature and is consumed by the turbojet engine in gaseous form.

### SUMMARY OF THE INVENTION

An object of the present invention is to provide an aircraft having an engine and a cooling system based on dihydrogen.

To that end, what is provided is an aircraft having:
an engine having a high-pressure compressor with multiple compression stages and a combustion chamber,
a fuel tank containing dihydrogen in liquid form,
devices to be heated,
a first air intake intended to draw, from the high-pressure compressor, air at a low pressure or at an intermediate pressure, and a second air intake intended to draw, from the high-pressure compressor, air at a high pressure,
a first heat exchanger,
a first pipe which passes through the first heat exchanger and feeds the devices to be heated downstream of the first heat exchanger, wherein, upstream of the first heat exchanger, the first pipe is divided into two sub-pipes, one of which is fluidically connected to the first air intake and the other of which is fluidically connected to the second air intake, and
a fuel pipe that is fluidically connected between the fuel tank and the combustion chamber of the engine and passes through the first heat exchanger.

The use of heat exchangers on the dihydrogen pipe makes it possible to regulate the temperature of the devices to be heated and of the engine, and to increase the temperature of the dihydrogen before its combustion.

According to one particular embodiment, the aircraft has, downstream of the first exchanger, a second heat exchanger through which pass the fuel pipe and a first oil circuit that draws oil from the engine and reinjects this oil into the engine after the oil has passed through the second heat exchanger.

According to one particular embodiment, the aircraft has an electric generator, and a third heat exchanger through which pass the fuel pipe and a second oil circuit that draws oil from the electric generator and reinjects this oil into the electric generator after the oil has passed through the third heat exchanger.

According to one particular embodiment, the aircraft has a nacelle which surrounds the engine and through which circulates an air flow, and a fourth heat exchanger through which passes the fuel pipe and a third circuit in which a heat-transfer fluid circulates, and wherein said third circuit circulates in the nacelle.

Advantageously, for each heat exchanger, the aircraft has a diversion pipe fluidically connected on the fuel pipe on either side of said heat exchanger and a regulating valve that is commanded to open and close and is installed on said diversion pipe.

### BRIEF DESCRIPTION OF THE DRAWINGS

The abovementioned features of the invention, along with others, will become more clearly apparent upon reading the following description of an exemplary embodiment, said description being given with reference to the appended drawings, in which:

FIG. 1 is a side view of an aircraft according to the invention,

FIG. 2 is a schematic depiction of an aircraft according to a first embodiment of the invention,

FIG. 3 is a schematic depiction of an aircraft according to a second embodiment of the invention,

FIG. 4 is a schematic depiction of an aircraft according to a third embodiment of the invention, and

FIG. 5 is a schematic depiction of an aircraft of the prior art.

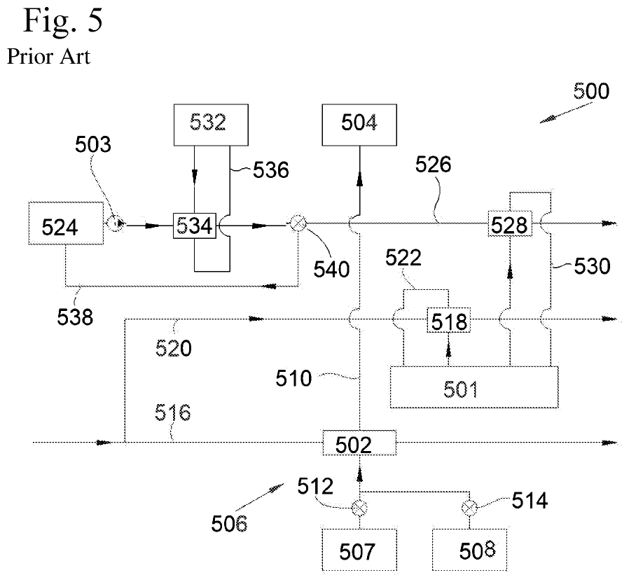

### DETAILED DESCRIPTION OF THE PREFERRED EMBODIMENTS

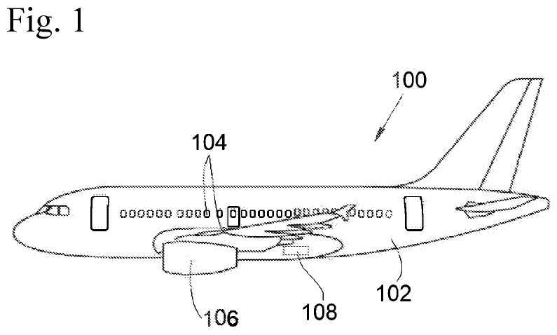

FIG. 1 shows an aircraft 100 having a fuselage 102 which internally delimits a cabin, including the space in which the passengers are seated, and the cockpit. The aircraft 100 also has deicing means, for example, for deicing the wings. The cabin and the deicing means constitute devices 104 to be heated. Of course, other elements of the aircraft 100 can be integrated in these devices 104 to be heated.

The aircraft 100 also has at least one propulsion system 106 having an engine incorporating, among other things, a gearbox, and taking the form of a turbojet engine or a turboprop engine that operates on dihydrogen, which is stored in liquid form in a fuel tank 108 disposed, for example, in the wings.

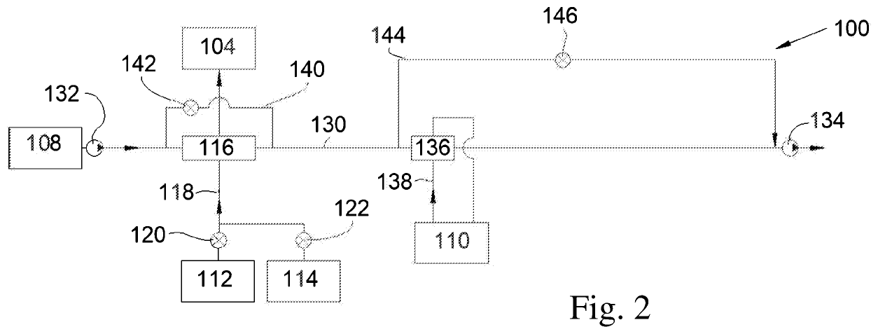

FIGS. 2, 3 and 4 show an aircraft 100, 300, 400 according to various embodiments of the invention.

The aircraft 100, 300, 400 thus has the engine 110 and the devices 104 to be heated.

The propulsion system 106 has a fan disposed in a fan duct and configured to generate an air flow in the engine 110 in a direction of movement of the air in the engine 110, wherein, in a known manner, the air flow then moves downstream of the fan in a primary duct or else in a secondary duct of the engine 110.

The engine 110 also has an engine compressor which has a low-pressure compressor downstream of the fan and a high-pressure compressor downstream of the low-pressure compressor, and an engine turbine which has a high-pressure turbine downstream of the high-pressure compressor, and a low-pressure turbine downstream of the high-pressure turbine.

The air which is blown by the fan and passes through the primary duct passes successively through the low-pressure compressor, the high-pressure compressor, the high-pressure turbine and the low-pressure turbine, whereupon the air is ejected towards the outside. Between the high-pressure compressor and the high-pressure turbine, the air passes through a combustion chamber in which the air is mixed with dihydrogen in order to burn the dihydrogen.

The high-pressure compressor has multiple compression stages in which the pressure increases, from upstream to downstream in the direction of movement, from a low pressure in the first stage to a high pressure in the last stage, passing through intermediate pressures in the intermediate stages.

The aircraft 100, 300, 400 also has a first air intake 112 configured to draw, from the high-pressure compressor, air at low pressure or at intermediate pressure, and a second air intake 114 configured to draw, from the high-pressure compressor, air at high pressure.

The aircraft 100, 300, 400 also has a first heat exchanger 116 and a first pipe 118 which passes through the first heat exchanger 116 and feeds the devices 104 to be heated downstream of the first heat exchanger 116 with respect to the direction of the flow in the first pipe 118.

Upstream of the first heat exchanger 116 with respect to the direction of the air flow in the first pipe 118, the first pipe 118 is divided into two sub-pipes, one of which is fluidically connected to the first air intake 112 and the other of which is fluidically connected to the second air intake 114. Each sub-pipe is, in this instance, equipped with a valve 120, 122 which makes it possible to regulate the passage of the air coming from each air intake 112, 114 depending on the requirements of the aircraft 100, 300, 400, and to this end, the aircraft 100, 300, 400 has a control unit or controller configured to command the valves 120, 122 to open and close.

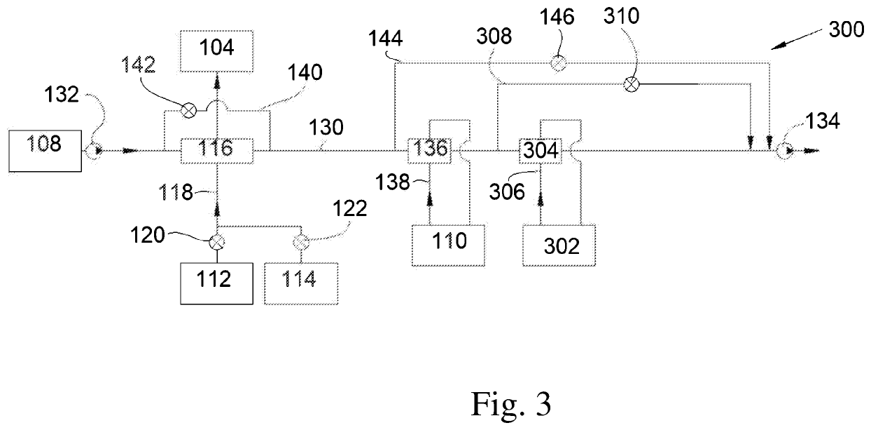

The aircraft 100, 300, 400 has the fuel tank 108 which makes it possible to store the dihydrogen in liquid form and a fuel pipe 130 that is fluidically connected between the fuel tank 108 and the combustion chamber of the engine 110 in order to feed it with dihydrogen from the fuel tank 108. At least one pump 132, 134 is arranged on the fuel pipe 130 to drive the dihydrogen into the fuel pipe 130. In the embodiment of the invention presented here, a pump 132 is arranged at the outlet of the fuel tank 108 so that there is sufficient pressure in the fuel pipe 130 and, so that there is sufficient pressure for the combustion chamber, a pump 134 is arranged downstream of a second diversion pipe 144 with respect to the direction of the flow of fuel in the fuel pipe 130, wherein the second diversion pipe 144 is described below. The optimization of the flow rates and/or pressures of dihydrogen in the fuel pipe 130 can result in the positions of the two pumps 132 and 134 being modified, as depicted in FIG. 3.

The first heat exchanger 116 is arranged on the fuel pipe 130 so as to allow an exchange of heat between the dihydrogen circulating in the fuel pipe 130 and the air circulating in the first pipe 118. In other words, the fuel pipe 130 passes through the first heat exchanger 116.

Thus, the hot air drawn in at the air intakes 112 and 114 is cooled on passing through the first heat exchanger 116 by the dihydrogen drawn in at the fuel tank 108, which is then heated and channeled towards the combustion chamber, while the cooled air is directed towards the devices 104 to be heated through the first pipe 118.

Thus, the temperature of the dihydrogen ensures that the air temperature drops and the heating of the dihydrogen ensures that it at least partially evaporates before its combustion. The first heat exchanger 116, moreover, has reduced bulk over that of the prior art. Moreover, the drawing in of air at the fan duct is reduced at the moment of take-off, thereby improving the performance of the engine 110.

The variants presented below ensure better evaporation of the dihydrogen by increasing the heat input.

According to a particular embodiment, and in order for the engine 110 to be cooled, the aircraft 100, 300, 400 has a second heat exchanger 136 which is configured to effect an exchange of heat between the flow of dihydrogen coming from the first heat exchanger 116 and a flow of oil coming from the engine 110.

To this end, the second heat exchanger 136 is also passed through by the fuel pipe 130 downstream of the first heat exchanger 116 with respect to the direction of the flow of fuel in the fuel pipe 130 and by a first oil circuit 138 that draws oil from the engine 110 and reinjects this oil into the engine 110 after it has passed through the second heat exchanger 136.

Thus, the hot oil drawn in at the engine 110 is cooled on passing through the second heat exchanger 136 by the dihydrogen circulating in the fuel pipe 130, which is then heated and channeled towards the combustion chamber of the engine 110, while the cooled oil is directed towards the engine 110.

Just as for the first heat exchanger 116, the exchange of heat energy causes the oil temperature to fall and the dihydrogen to be heated before its combustion.

In order to regulate the flow of dihydrogen in the first heat exchanger 116, the aircraft 100, 300, 400 has a first diversion pipe 140 fluidically connected on the fuel pipe 130 on either side of the first heat exchanger 116, and a regulating valve 142 commanded to open and close by the control unit is installed on the first diversion pipe 140.

In the same way, in order to regulate the flow of dihydrogen in the second heat exchanger 136, the aircraft 100, 300, 400 has a second diversion pipe 144 fluidically connected on the fuel pipe 130 on either side of the second heat exchanger 136, and a regulating valve 146 commanded to open and close by the control unit is installed on the second diversion pipe 144.

In the embodiment of FIG. 3, the aircraft 300 has an electric generator 302 which generates an electric current for supplying the aircraft 300.

In order to ensure the cooling of the electric generator 302, the aircraft 300 has a third heat exchanger 304 which is configured to effect an exchange of heat between the dihydrogen circulating in the fuel pipe 130 and a flow of oil coming from the electric generator 302.

To this end, the third heat exchanger 304 is passed through by the fuel pipe 130 and by a second oil circuit 306 that draws oil from the electric generator 302 and reinjects this oil into the electric generator 302 after the oil has passed through the third heat exchanger 304.

Thus, the hot oil drawn in at the electric generator 302 is cooled on passing through the third heat exchanger 304 by the dihydrogen, which is then heated and conveyed towards the combustion chamber, while the cooled oil is directed towards the electric generator 302.

In the embodiment of the invention presented here, the third heat exchanger 304 is disposed downstream of the first and the second heat exchanger 116 and 136 with respect to the direction of the flow of fuel in the fuel pipe 130, but a different order is possible.

In order to regulate the flow of dihydrogen in the third heat exchanger 304, the aircraft 300 has a third diversion pipe 308 fluidically connected on the fuel pipe 130 on either side of the third heat exchanger 304, and a regulating valve 310 commanded to open and close by the control unit is installed on the third diversion pipe 308.

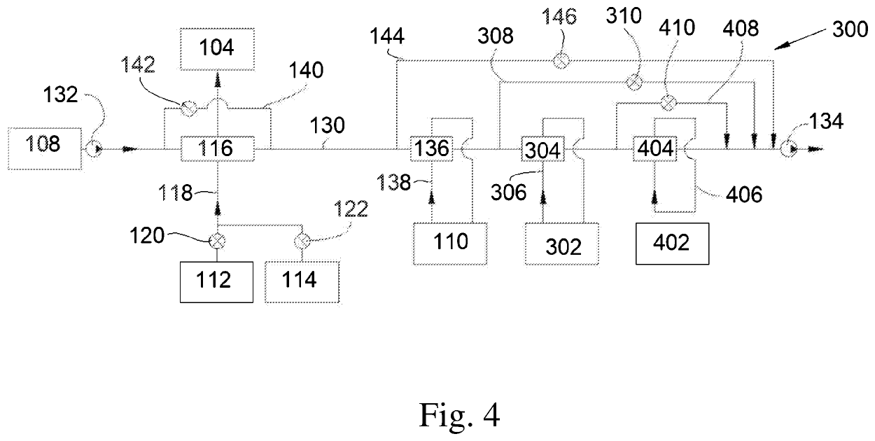

In the embodiment of FIG. 4, the aircraft 400 has a nacelle 402 which surrounds the engine 110 and through which circulates an air flow which is, in particular, heated by the engine 110.

In order to ensure the cooling of the air flow circulating in the nacelle 402, the aircraft 400 has a fourth heat exchanger 404 which is configured to effect an exchange of heat between the dihydrogen circulating in the fuel pipe 130 and a flow of a heat-transfer fluid circulating in a third circuit 406 circulating in the nacelle 402.

To this end, the fourth heat exchanger 404 is passed through by the fuel pipe 130 and by the third circuit 406, in which circulates the heat-transfer fluid which becomes loaded with heat energy as it passes through the nacelle 402 and which releases its heat energy as it passes through the fourth heat exchanger 404.

At the nacelle, the third circuit 406 may take, for example, the form of a pipework assembly in contact with the engine 110 to exchange heat by conduction, and/or the form of a pipework assembly in contact with the air flow circulating in the nacelle 402 to exchange heat by convection.

Thus, when the heat-transfer fluid passes through the nacelle 402, it becomes loaded with heat energy that it releases as it passes through the fourth heat exchanger 404 via the dihydrogen, which is then heated and conveyed towards the combustion chamber, while the cooled heat-transfer fluid circulates in a loop.

In the embodiment of the invention presented here, the fourth heat exchanger 404 is disposed downstream of the first, the second and the third heat exchanger 116, 136 and 304 with respect to the direction of the flow of fuel in the fuel pipe 130, but a different order is possible.

In order to regulate the flow of dihydrogen in the fourth heat exchanger 404, the aircraft 400 has a fourth diversion pipe 408 fluidically connected on the fuel pipe 130 on either side of the fourth heat exchanger 404, and a regulating valve 410 commanded to open and close by the control unit is installed on the fourth diversion pipe 408.

In the embodiment of the invention of FIGS. 3 and 4, the second, third and fourth diversion pipes 144, 308 and 408 all open out in the fuel pipe 130 downstream of the fourth heat exchanger 404 with respect to the direction of the flow of fuel in the fuel pipe 130, but it is possible that each diversion pipe 144, 308, 408 opens out in the fuel pipe 130 just downstream of the corresponding heat exchanger 136, 304, 404.

In the embodiment of the invention presented in FIG. 2, the temperature of the engine 110 is regulated by the second heat exchanger 136; in the embodiment of FIG. 3, the temperature of the engine 110 is regulated by the second heat exchanger 136 and the temperature of the electric generator 302 is regulated by the third heat exchanger 304; and in the embodiment of FIG. 4, the temperature of the engine 110 is regulated by the second heat exchanger 136, the temperature of the electric generator 302 is regulated by the third heat exchanger 304 and the temperature of the air flow from the nacelle 402 is regulated by the fourth heat exchanger 404, but it is possible to envisage other combinations. For example, it is possible to regulate solely the temperature of the electric generator 302, or the temperature of the air flow from the nacelle 402, or the temperature of the engine 110 and the temperature of the air flow from the nacelle 402, or the temperature of the air flow from the nacelle 402 and the temperature of the electric generator 302.

In order to allow stable regulation of the flow rate of dihydrogen throughout all of the flight phases, an accumulator may be installed on the line between the tank 108 and the pump 134.

Another exchanger may be added along the fuel pipe 130 between the pumps 132 and 134 if the heat recovered is still not enough to increase the temperature of the fuel before it is introduced into the combustion chamber. This exchanger, which can be activated or deactivated depending on requirements and on flight phases, draws in outside air (in the secondary duct, for example) in order to regulate the temperature of the fuel. This exchanger may also be positioned on the third circuit 406 and thus exchange heat indirectly with the fuel by way of the heat-transfer fluid.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
an engine having a high-pressure compressor with multiple compression stages and a combustion chamber,
a fuel tank containing dihydrogen in liquid form,
devices to be heated,
a first air intake configured to draw, from the high-pressure compressor, air at a low pressure or at an intermediate pressure, and a second air intake configured to draw, from the high-pressure compressor, air at a high pressure,
a first heat exchanger,
a first pipe which passes through the first heat exchanger and feeds the devices to be heated downstream of the first heat exchanger, wherein, upstream of the first heat exchanger, the first pipe is divided into two sub-pipes, one of which is fluidically connected to the first air intake and the other of which is fluidically connected to the second air intake, and
a fuel pipe fluidically connected between the fuel tank and the combustion chamber of the engine and passes through the first heat exchanger.

2. The aircraft according to claim 1, further comprising, downstream of the first exchanger, a second heat exchanger through which pass the fuel pipe and a first oil circuit that draws oil from the engine and reinjects this oil into the engine after the oil has passed through the second heat exchanger.

3. The aircraft according to claim 1, further comprising an electric generator, and a third heat exchanger through which pass the fuel pipe and a second oil circuit that draws oil from the electric generator and reinjects this oil into the electric generator after the oil has passed through the third heat exchanger.

4. The aircraft according to claim 1, further comprising a nacelle which surrounds the engine and through which circulates an air flow, and a fourth heat exchanger through which passes the fuel pipe and a third circuit in which a heat-transfer fluid circulates, and wherein said third circuit circulates in the nacelle.

5. The aircraft according to claim 1, wherein, for the first heat exchanger, the aircraft has a diversion pipe fluidically connected on the fuel pipe on either side of said heat exchanger and a regulating valve that is commanded to open and close and is installed on said diversion pipe.
